(19) United States
(12) Patent Application Publication
(10) Pub. No.: US 2018/0068679 A1
(43) Pub. Date: Mar. 8, 2018

(54) MAGNETIC HEAD AND MAGNETIC RECORDING AND REPRODUCING DEVICE

(71) Applicant: Kabushiki Kaisha Toshiba, Tokyo (JP)

(72) Inventors: Masayuki TAKAGISHI, Tokyo (JP); Kenichiro YAMADA, Tokyo (JP); Naoyuki NARITA, Fujisawa (JP); Tomoyuki MAEDA, Kawasaki (JP); Katsuya SUGAWARA, Kawasaki (JP); Yousuke ISOWAKI, Yokohama (JP)

(73) Assignee: Kabushiki Kaisha Toshiba, Tokyo (JP)

(21) Appl. No.: 15/443,760

(22) Filed: Feb. 27, 2017

(30) Foreign Application Priority Data
Sep. 6, 2016 (JP) 2016-173474

(51) Int. Cl. G11B 5/31; H02K 41/035; H02P 6/08

(52) U.S. Cl. CPC G11B 5/315; H02P 6/08; H02K 41/0354

(57) ABSTRACT

According to one embodiment, a magnetic head includes a magnetic pole, and a coil. The coil includes a first coil portion separated from the magnetic pole in a first direction. The magnetic pole includes a magnetic pole end portion, and first and second magnetic pole edge portions connected to the magnetic pole end portion. The first coil portion includes first and second coil edge portions, and a third coil edge portion overlapping the magnetic pole and being connected to the first and second coil edge portions. The first magnetic pole edge portion includes a first magnetic pole overlap portion overlapping the first coil edge portion. The second magnetic pole edge portion includes a second magnetic pole overlap portion overlapping the second coil edge portion. The magnetic pole end portion has a magnetic pole end portion center in a second direction connecting the first and second magnetic pole overlap portions.

### CROSS-REFERENCE TO RELATED APPLICATIONS

This application is based upon and claims the benefit of priority from Japanese Patent Application No. 2016-173474, filed on Sep. 6, 2016; the entire contents of which are incorporated herein by reference.

### FIELD

Embodiments described herein relate generally to a magnetic head and a magnetic recording and reproducing device.

### BACKGROUND

Information is recorded in a magnetic storage medium such as a HDD (Hard Disk Drive), etc., by using a magnetic head. It is desirable to increase the transfer speed of the magnetic head and a magnetic recording and reproducing device.

### BRIEF DESCRIPTION OF THE DRAWINGS

FIG. 1A to FIG. 1F are schematic views illustrating a magnetic head according to a first embodiment;

FIG. 2A and FIG. 2B are schematic views illustrating a magnetic head according to a first embodiment;

FIG. 3A to FIG. 3C are schematic views illustrating magnetic heads;

FIG. 4 is a graph illustrating characteristics of the magnetic heads;

FIG. 5A and FIG. 5B are schematic perspective views illustrating other magnetic heads according to the first embodiment;

FIG. 6A and FIG. 6B are schematic perspective views illustrating other magnetic heads according to the first embodiment;

FIG. 7 is a graph illustrating a characteristic of the magnetic head;

FIG. 8 is a schematic perspective view illustrating another magnetic head according to the first embodiment;

FIG. 9A and FIG. 9B are schematic views illustrating another magnetic head according to the first embodiment;

FIG. 10 is a schematic side view illustrating another magnetic head according to the first embodiment;

FIG. 11 is a schematic perspective view illustrating a portion of a magnetic recording and reproducing device according to a second embodiment;

FIG. 12 is a schematic perspective view illustrating the magnetic recording and reproducing device according to the second embodiment; and

FIG. 13A and FIG. 13B are schematic perspective views illustrating portions of the magnetic recording and reproducing device according to the second embodiment.

### DETAILED DESCRIPTION

According to one embodiment, a magnetic head includes a magnetic pole, and a coil. The coil includes a first coil portion separated from the magnetic pole in a first direction. The magnetic pole includes a magnetic pole end portion, a first magnetic pole edge portion connected to the magnetic pole end portion, and a second magnetic pole edge portion connected to the magnetic pole end portion. The first coil portion includes a first coil edge portion, a second coil edge portion, and a third coil edge portion overlapping the magnetic pole in the first direction and being connected to the first coil edge portion and the second coil edge portion. The first magnetic pole edge portion includes a first magnetic pole overlap portion overlapping the first coil edge portion in the first direction. The second magnetic pole edge portion includes a second magnetic pole overlap portion overlapping the second coil edge portion in the first direction. The magnetic pole end portion has a magnetic pole end portion center in a second direction connecting the first magnetic pole overlap portion and the second magnetic pole overlap portion. A distance in the second direction between the first magnetic pole edge portion and a first straight line increases along a third direction. The third direction is from the magnetic pole end portion center toward the overlap portion center. The first straight line connects the magnetic pole end portion center and an overlap portion center. The overlap portion center is between the first magnetic pole overlap portion and the second magnetic pole overlap portion. A distance in the second direction between the first coil edge portion and a second straight line decreases along the third direction. The second straight line passes through the third coil edge portion and is parallel to the first straight line.

According to another embodiment, a magnetic recording and reproducing device includes the magnetic head described above, and a magnetic recording medium. Information is recorded in the magnetic recording medium by the magnetic pole.

Various embodiments will be described hereinafter with reference to the accompanying drawings.

The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions.

In the specification and drawings, components similar to those described or illustrated in a drawing thereinabove are marked with like reference numerals, and a detailed description is omitted as appropriate.

### First Embodiment

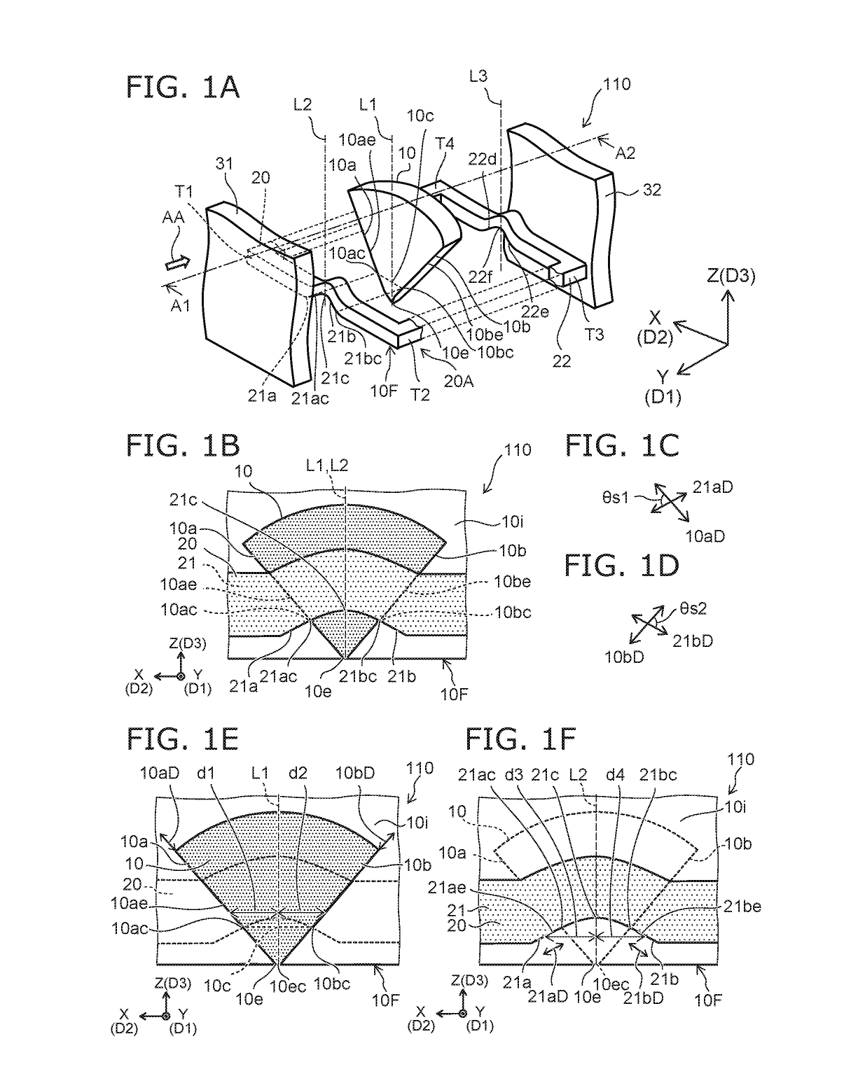

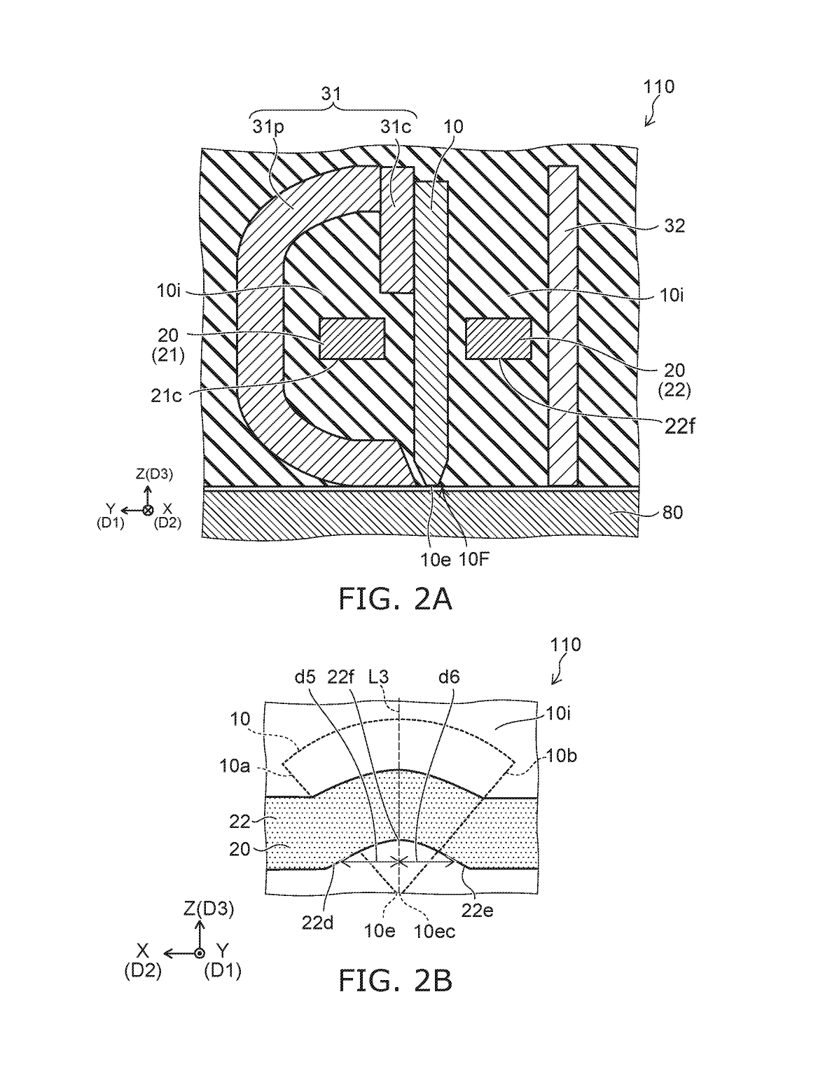

FIG. 1A to FIG. 1F, FIG. 2A, and FIG. 2B are schematic views illustrating a magnetic head according to a first embodiment.

FIG. 1A is a perspective view. FIG. 1B, FIG. 1E, FIG. 1F, and FIG. 2B are perspective side views when viewed along arrow direction AA shown in FIG. 1A for some of the components shown in FIG. 1A. FIG. 1C and FIG. 1D are schematic views showing angles. FIG. 2A is a line A1-A2 cross-sectional view of FIG. 1A. For easier viewing of the drawing in FIG. 1A, the components are drawn as being separated from each other; and some of the components such as the insulating portions, etc., are not illustrated.

As shown in FIG. 1A, the magnetic head 110 according to the first embodiment includes a magnetic pole 10 and a coil 20. In the example, the magnetic head 110 further includes a first shield 31 and a second shield 32. The first shield 31 is, for example, a trailing shield. The second shield 32 is, for example, a leading shield.

The magnetic pole 10 and the coil 20 are disposed between the first shield 31 and the second shield 32.

In the example, the coil 20 includes a first coil portion 21 and a second coil portion 22. At least a portion of the magnetic pole 10 is disposed between the first coil portion 21 and the second coil portion 22.

In FIG. 1B, the first coil portion 21 and the magnetic pole 10 are drawn as being extracted. In FIG. 1E, the magnetic pole 10 is drawn by solid lines; and the first coil portion 21 is drawn by broken lines. In FIG. 1F, the first coil portion 21 is drawn by solid lines; and the magnetic pole 10 is drawn by broken lines. In FIG. 2B, the second coil portion 22 is drawn by solid lines; and the magnetic pole 10 is drawn by broken lines.

As shown in FIG. 1A, for example, the first coil portion 21 is disposed between at least a portion of the first shield 31 and at least a portion of the magnetic pole 10. For example, the second coil portion 22 is disposed between at least a portion of the second shield 32 and at least a portion of the magnetic pole 10. In the embodiment, the first coil portion 21 and the second coil portion 22 may be interchanged with each other.

The first coil portion 21 includes a first coil end T1 and a second coil end T2. For example, the magnetic pole 10 is magnetically excited by causing a current (e.g., a recording current) to flow between the first coil end T1 and the second coil end T2. The second coil portion 22 includes a third coil end T3 and a fourth coil end T4. For example, the magnetic pole 10 is magnetically excited by causing a current (e.g., the recording current) to flow between the third coil end T3 and the fourth coil end T4. Flux that is based on the current is generated from the magnetic pole 10.

For example, the second coil end T2 may be connected to the third coil end T3. In such a case, for example, the first coil end T1 and the fourth coil end T4 are used as supply terminals of the current.

As shown in FIG. 2A, the magnetic head 110 is disposed to oppose a magnetic recording medium 80. The magnetic head 110 has a medium-opposing surface 10F (an Air Bearing Surface (ABS)). The flux that is generated from the magnetic pole 10 is applied to the magnetic recording medium 80; and information is recorded in the magnetic recording medium 80. The magnetic pole 10 is, for example, a major electrode.

As shown in FIG. 2A, the magnetic head 110 includes an insulating portion 10i. For example, the insulating portion 10i covers at least a portion of the magnetic pole 10, the coil 20, the first shield 31, and the second shield 32 and between the magnetic pole 10, the coil 20, the first shield 31, and the second shield 32.

The first shield 31 includes a contact portion 31c and a shield portion 31p. The first coil portion 21 is provided between the shield portion 31p and the magnetic pole 10. The contact portion 31c substantially contacts the magnetic pole 10. At least a portion of the contact portion 31c is positioned between a portion of the shield portion 31p and a portion of the magnetic pole 10. For example, the contact portion 31c is continuous with the shield portion 31p. For example, the magnetic pole 10 includes a portion contacting the contact portion 31c. Flux along the direction from the contacting portion toward a magnetic pole end portion 10e is formed inside the magnetic pole 10. A magnetic field that is based on the flux is applied to the magnetic recording medium 80. Information that corresponds to the orientation of the flux is recorded in the recording bits of the magnetic recording medium 80.

As shown in FIG. 1A, a direction from the magnetic pole 10 toward the first coil portion 21 is taken as a first direction D1. The first direction D1 is taken as a Y-axis direction. One direction perpendicular to the Y-axis direction is taken as an X-axis direction. A direction perpendicular to the Y-axis direction and the X-axis direction is taken as a Z-axis direction. The Y-axis direction (the first direction D1) corresponds to the down-track direction. The X-axis direction corresponds to the track width direction. The Z-axis direction corresponds to the height direction.

As shown in FIG. 1A, the magnetic pole 10 has a fan-like configuration. The width (the length in the X-axis direction) of the magnetic pole 10 increases away from the medium-opposing surface 10F. The width of the magnetic pole 10 increases along the upward direction. On the other hand, the first coil portion 21 has a portion that is curved toward the upward direction. This configuration will now be described.

As shown in FIG. 1A, FIG. 1B, and FIG. 1E, the magnetic pole 10 includes a magnetic pole end portion 10e, a first magnetic pole edge portion 10a, and a second magnetic pole edge portion 10b. The magnetic pole end portion 10e is the end on the medium-opposing surface 10F side. The first magnetic pole edge portion 10a is connected to the magnetic pole end portion 10e. The second magnetic pole edge portion 10b is connected to the magnetic pole end portion 10e. These magnetic pole edge portions are edges of the magnetic pole 10. These magnetic pole end portions extend upward (obliquely upward) from the medium-opposing surface 10F.

On the other hand, as shown in FIG. 1A, FIG. 1B, and FIG. 1F, the first coil portion 21 includes a first coil edge portion 21a, a second coil edge portion 21b, and a third coil edge portion 21c. These coil edge portions are, for example, edges of the first coil portion 21 on the medium-opposing surface 10F side. The third coil edge portion 21c is connected to the first coil edge portion 21a and the second coil edge portion 21b. In the X-axis direction, the third coil edge portion 21c is between the first coil edge portion 21a and the second coil edge portion 21b. The third coil edge portion 21c overlaps the magnetic pole 10 in the first direction D1 (the Y-axis direction).

As shown in FIG. 1B, the first magnetic pole edge portion 10a includes a first magnetic pole overlap portion 10ac. The first magnetic pole overlap portion 10ac overlaps the first coil edge portion 21a in the first direction D1. The second magnetic pole edge portion 10b includes a second magnetic pole overlap portion 10bc. The second magnetic pole overlap portion 10bc overlaps the second coil edge portion 21b in the first direction D1.

A direction that connects the first magnetic pole overlap portion 10ac and the second magnetic pole overlap portion 10bc is taken as a second direction D2. For example, the second direction D2 is aligned with the X-axis direction.

As shown in FIG. 1E, a magnetic pole end portion center 10ec is the center in the X-axis direction of the magnetic pole end portion 10e. Thus, the magnetic pole end portion 10e has the magnetic pole end portion center 10ec in the second direction D2.

An overlap portion center 10c is the midpoint of the first magnetic pole overlap portion 10ac and the second magnetic pole overlap portion 10bc. The overlap portion center 10c is the center between the first magnetic pole overlap portion 10ac and the second magnetic pole overlap portion 10bc. A first straight line L1 is a straight line connecting the overlap portion center 10c and the magnetic pole end portion center 10ec recited above. For example, the first straight line L1 is aligned with the Z-axis direction. For example, the first straight line L1 is substantially perpendicular to the medium-opposing surface 10F.

As shown in FIG. 1E, the distance (a first distance d1) in the second direction D2 (e.g., the X-axis direction) between the first straight line L1 and the first magnetic pole edge portion 10a increases along the upward direction. The first distance d1 increases along a third direction D3 from the magnetic pole end portion center 10ec toward the overlap portion center 10c. For example, the third direction D3 is aligned with the Z-axis direction. The first distance d1 increases away from the medium-opposing surface 10F.

For example, the distance (a second distance d2) in the second direction D2 between the first straight line L1 and the second magnetic pole edge portion 10b increases along the third direction D3 (along the upward direction). The second distance d2 increases away from the medium-opposing surface 10F.

The sum of the first distance d1 and the second distance d2 corresponds to the width (the width in the track width direction) of the magnetic pole 10. Thus, the width of the magnetic pole 10 increases along the upward direction.

On the other hand, as shown in FIG. 1A, FIG. 1B, and FIG. 1F, a second straight line L2 is the straight line parallel to the first straight line L1 and passing through the third coil edge portion 21c. The distance (a third distance d3) in the second direction D2 between the second straight line L2 and the first coil edge portion 21a decreases along the third direction. The third distance d3 decreases along the upward direction. The third distance d3 decreases away from the medium-opposing surface 10F.

The distance (a fourth distance d4) in the second direction D2 between the second straight line L2 and the second coil edge portion 21b decreases along the third direction. The fourth distance d4 decreases away from the medium-opposing surface 10F.

For example, the central portion of the edge of the first coil portion 21 (the third coil edge portion 21c) is positioned on the first coil edge portion 21a and the second coil edge portion 21b using the medium-opposing surface 10F as the reference. For example, the position in the third direction D3 (e.g., the Z-axis direction) of the first coil edge portion 21a is between the position in the third direction D3 of the third coil edge portion 21c and the position in the third direction D3 of the magnetic pole end portion 10e. The position in the third direction D3 of the second coil edge portion 21b is between the position in the third direction D3 of the third coil edge portion 21c and the position in the third direction D3 of the magnetic pole end portion 10e. In the first coil portion 21, for example, the first coil edge portion 21a and the second coil edge portion 21b are tilted with respect to the Z-axis direction.

Thus, in the magnetic head 110 according to the embodiment, the edge portions of the magnetic pole 10 are tilted so that the width of the magnetic pole 10 increases upward. On the other hand, the first coil edge portion 21a and the second coil edge portion 21b of the first coil portion 21 are tilted. The directions of the tilts of the edge portions of the magnetic pole 10 are the reverse of the orientations of the tilts of the edge portions of the first coil portion 21.

Thereby, for example, the edge portions of the magnetic pole 10 and the edge portions of the first coil portion 21 cross at large angles. Thereby, as described below, the transfer speed can be increased.

Examples of the crossing states between the edge portions of the magnetic pole 10 and the edge portions of the first coil portion 21 will now be described.

As shown in FIG. 1E, the first magnetic pole edge portion 10a includes a first magnetic pole extension portion 10ae. The first magnetic pole extension portion 10ae includes the first magnetic pole overlap portion 10ac recited above. The first magnetic pole extension portion 10ae is aligned with a first magnetic pole extension direction 10aD.

The second magnetic pole edge portion 10b includes a second magnetic pole extension portion 10be. The second magnetic pole extension portion 10be includes the second magnetic pole overlap portion 10bc recited above. The second magnetic pole extension portion 10be is aligned with a second magnetic pole extension direction 10bD.

On the other hand, as shown in FIG. 1F, the first coil edge portion 21a includes a first coil overlap portion 21ac. The first coil overlap portion 21ac overlaps the first magnetic pole edge portion 10a in the first direction D1. The first coil edge portion 21a includes a first coil extension portion 21ae. The first coil extension portion 21ae includes the first coil overlap portion 21ac. The first coil extension portion 21ae is aligned with a first coil extension direction 21aD.

The second coil edge portion 21b includes a second coil overlap portion 21bc. The second coil overlap portion 21bc overlaps the second magnetic pole edge portion 10b in the first direction D1. The second coil edge portion 21b includes a second coil extension portion 21be. The second coil extension portion 21be includes the second coil overlap portion 21bc. The second coil extension portion 21be is aligned with a second coil extension direction 21bD.

The first magnetic pole extension direction 10aD and the first coil extension direction 21aD cross each other. The second magnetic pole extension direction 10bD and the second coil extension direction 21bD cross each other.

FIG. 1C illustrates the first magnetic pole extension direction 10aD and the first coil extension direction 21aD. A first crossing angle θs1 is the angle (the absolute value) between the first magnetic pole extension direction 10aD and the first coil extension direction 21aD. In the embodiment, the first crossing angle θs1 can be set to be large. For example, the first crossing angle θs1 is greater than 45 degrees.

FIG. 1D illustrates the second magnetic pole extension direction 10bD and the second coil extension direction 21bD. A second crossing angle θs2 is the angle (the absolute value) between the second magnetic pole extension direction 10bD and the second coil extension direction 21bD. In the embodiment, the second crossing angle θs2 can be set to be large. For example, the second crossing angle θs2 is greater than 45 degrees.

In the embodiment, these crossing angles can be set to be large. Thereby, as described below, a magnetic head and a magnetic recording and reproducing device can be provided in which the transfer speed can be increased.

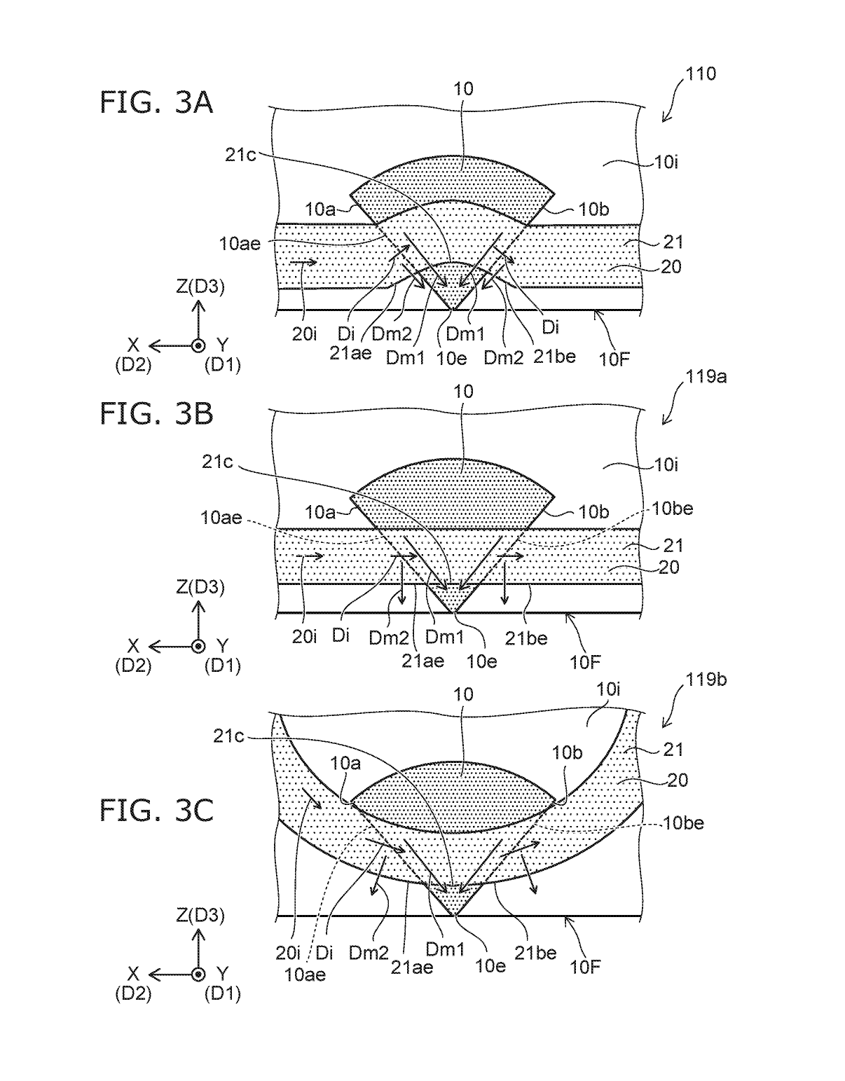

FIG. 3A to FIG. 3C are schematic views illustrating magnetic heads.

FIG. 3A corresponds to the magnetic head 110 according to the embodiment. FIG. 3B corresponds to a magnetic head 119a of a first reference example. For example, the magnetic head 119a corresponds to a general toroidal coil-type. FIG. 3C corresponds to a magnetic head 119b of a second reference example. For example, the magnetic head 119b corresponds to a general pancake-type.

In the magnetic head 110 as shown in FIG. 3A, a current 20i is caused to flow in the coil 20 (the first coil portion 21). In the first coil edge portion 21a, a direction Di of the current 20i is toward the upper right in the drawing. Therefore, a direction Dm2 of the magnetic field generated in the first coil edge portion 21a is toward the lower right in the drawing. On the other hand, in the second coil edge portion 21b, the direction Di of the current 20i is toward the lower right in the drawing. Therefore, the direction Dm2 of the magnetic field generated in the second coil edge portion 21b is toward the lower left in the drawing.

On the other hand, the configuration of the magnetic pole 10 is a substantially fan-like configuration. Therefore, a direction Dmf in which the flux concentrates is toward the lower right in the drawing at the vicinity of the first magnetic pole edge portion 10a. The direction Dmf in which the flux concentrates is toward the lower left in the drawing at the vicinity of the second magnetic pole edge portion 10b.

Thus, the direction Dm2 of the magnetic field based on the current 20i is aligned with the direction in which the flux concentrates in the magnetic pole 10. Therefore, the magnetic field of the magnetic pole 10 changes easily according to the change of the current. Thereby, for example, the delay can be small for the change of the magnetic field applied to the magnetic recording medium. The transfer speed can be increased.

In the magnetic head 119a of the first reference example shown in FIG. 3B, a curved portion is not provided in the coil 20 (the first coil portion 21). In other words, the first coil edge portion 21a and the second coil edge portion 21b are not tilted with respect to the Z-axis direction and are perpendicular to the Z-axis direction. Therefore, the direction Di of the current 20i in the first coil edge portion 21a and the second coil edge portion 21b is the lateral direction in the drawing. Therefore, the direction Dm2 of the magnetic field generated in the first coil edge portion 21a and the second coil edge portion 21b is the vertical direction in the drawing. The direction Dm2 of the magnetic field based on the current 20i is not aligned with the direction in which the flux concentrates in the magnetic pole 10. The direction Dm2 of the magnetic field crosses the direction in which the flux concentrates at a large angle. Therefore, the magnetic field of the magnetic pole 10 does not change easily according to the change of the current. A delay occurs for the change of the magnetic field applied to the magnetic recording medium. Therefore, the transfer speed is low.

In the magnetic head 119b as shown in FIG. 3C, the state of the modification of the coil 20 is the reverse of the magnetic head 110. In the magnetic head 119b, the direction Di of the current 20i in the first coil edge portion 21a is toward the lower right in the drawing. Therefore, the direction Dm2 of the magnetic field generated in the first coil edge portion 21a is toward the lower left in the drawing. The direction Di of the current 20i in the second coil edge portion 21b is toward the upper right in the drawing. Therefore, the direction Dm2 of the magnetic field generated in the second coil edge portion 21b is toward the lower right in the drawing. The direction Dmf in which the flux concentrates in the magnetic pole 10 is toward the lower right in the drawing at the vicinity of the first magnetic pole edge portion 10a. The direction Dmf in which the flux concentrates is toward the lower left in the drawing at the vicinity of the second magnetic pole edge portion 10b. The direction Dm2 of the magnetic field based on the current 20i crosses the direction in which the flux concentrates in the magnetic pole 10 at a large angle. Therefore, for example, a delay occurs for the change of the magnetic field applied to the magnetic recording medium. Therefore, the transfer speed is low.

Thus, in the magnetic head 110 according to the embodiment, the magnetic pole 10 has a fan-like configuration. The width of the end of the magnetic pole 10 on the medium-opposing surface 10F side (the magnetic pole end portion 10e) is set to be small. Thereby, the flux is concentrated efficiently. In such a case, the configuration of a portion of the coil 20 is set to a curved configuration. Thereby, the direction Dm2 of the magnetic field generated by the current 20i is set to be aligned with the direction in which the flux concentrates in the magnetic pole 10. Thereby, the response of the magnetic field generated in the magnetic pole 10 can be improved.

For example, there is a reference example in which the yoke length (the length in the height direction of the magnetic pole) is set to be small to improve the response of the magnetic field. The manufacturing is difficult when the yoke length is set to be small. Therefore, methods in which the yoke length is set to be small are limited. It is considered that the improvement of the response in a method in which the yoke length is set to be small is based on an effect from the interaction between the relaxation time (τ) of the yoke magnetization and the magnetic circuit of the entire yoke (referring to M. Takagishi, IEEE Trans. Magn., vol. 33(5) p 2821 1997). In other words, the configuration does not consider the relationship between the direction Dm2 of the magnetic field generated by the current 20i and the direction in which the flux concentrates in the magnetic pole 10.

There are attempts to improve the response of the magnetic field by using a toroidal coil-type or pancake-type coil. For example, these methods increase the response speed of the coil by setting the impedance to be small. In other words, the configuration does not consider the relationship between the direction Dm2 of the magnetic field generated by the current 20i and the direction in which the flux concentrates in the magnetic pole 10.

Conversely, the special configuration according to the embodiment is based on a novel approach considering the relationship between the direction Dm2 of the magnetic field generated by the current 20i and the direction in which the flux concentrates in the magnetic pole 10.

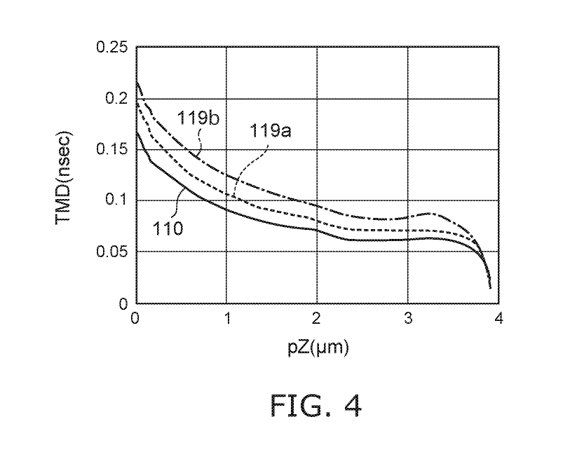

FIG. 4 is a graph illustrating characteristics of the magnetic heads.

FIG. 4 illustrates simulation results of the characteristics of the magnetic heads 110, 119a, and 119b recited above. For the three magnetic heads, the configuration of the magnetic pole 10 is the same; and the configuration of the coil 20 (the first coil portion 21) is different. The simulation is based on the LLG equations (Landau-Liftshitz-Gilbert-Langevin equations). The horizontal axis of FIG. 4 is a position pZ (μm) in the Z-axis direction. The position where the position pZ is 0 corresponds to the medium-opposing surface 10F. The vertical axis of FIG. 4 is a phase lag TMD (nsec) of the magnetization of the magnetic pole 10. The phase lag TMD is the phase lag of each portion of the yoke magnetization when the phase of the recording current for a transfer speed of 2.9 Gbps (Giga-bits per second) is used as the reference.

As shown in FIG. 4, the phase lag TMD is large in the magnetic heads 119a and 119b. Conversely, the phase lag TMD is small in the magnetic head 110. The phase lag TMD of the magnetic head 110 is about 80% of the phase lag TMD of the magnetic head 119b.

Thus, according to the embodiment, the phase lag TMD can be small. Thereby, the transfer speed can be increased.

In the embodiment as described above, the direction Dm2 of the magnetic field based on the current 20i is aligned with the direction in which the flux concentrates in the magnetic pole 10. This means that the angle is large between the direction in which the edge portion of the coil 20 extends and the direction in which the flux concentrates in the magnetic pole 10. In one configuration, this angle corresponds to the angle (the first crossing angle θs1 of FIG. 1C) between the first magnetic pole extension direction 10aD and the first coil extension direction 21aD. In one configuration, this angle corresponds to the angle (the second crossing angle θs2 referring to FIG. 1D) between the second magnetic pole extension direction 10bD and the second coil extension direction 21bD.

In the embodiment, various modifications of the configuration of the magnetic pole 10 are possible. The state of the flux inside the magnetic pole 10 also is dependent on, for example, the configuration of the first shield 31. Examples of parameters relating to the flow of the flux will now be described.

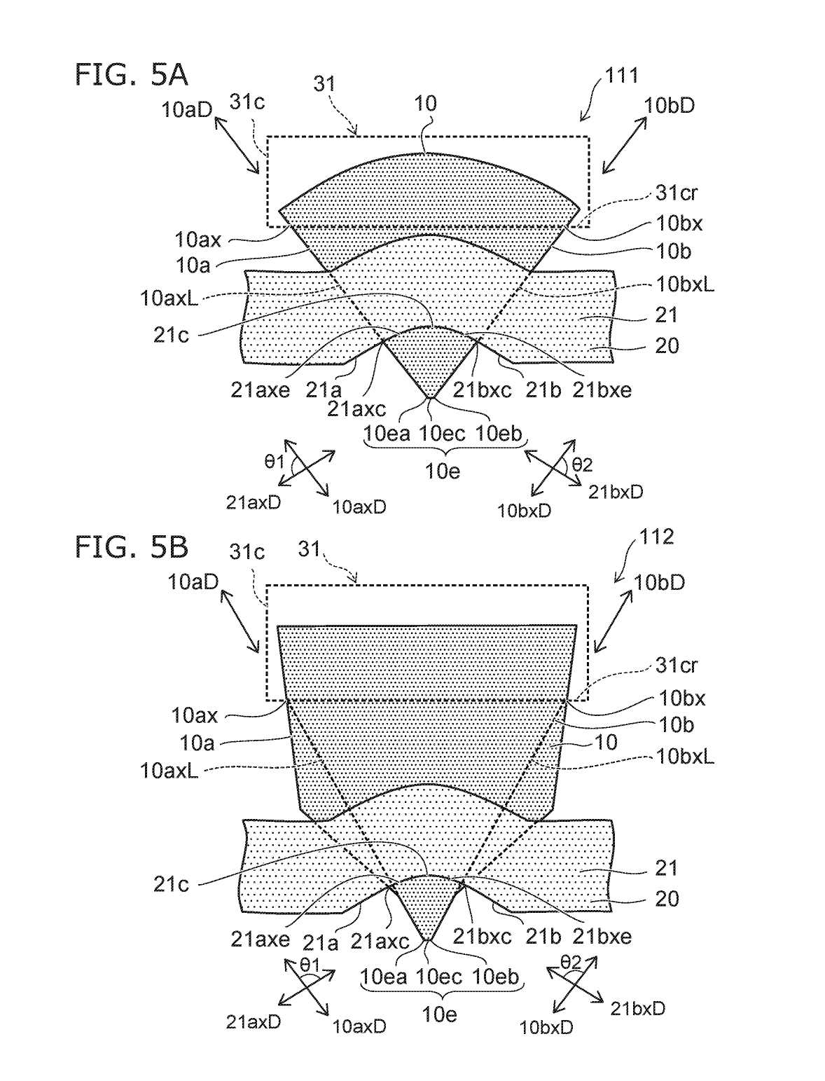

FIG. 5A and FIG. 5B are schematic perspective views illustrating other magnetic heads according to the first embodiment.

In these drawings, the contact portion 31c of the first shield 31 (referring to FIG. 2A), the magnetic pole 10, and the first coil portion 21 are drawn; and the other components are not illustrated.

As shown in FIG. 5A and FIG. 5B, the magnetic head 111 and the magnetic head 112 according to the embodiment include the first shield 31 including the contact portion 31c. The contact portion 31c contacts a portion of the magnetic pole 10. In these examples, the width (the length along the X-axis direction) of the contact portion 31c is wider than the width of the magnetic pole 10.

As shown in FIG. 5A, the first magnetic pole edge portion 10a of the magnetic pole 10 includes a first magnetic pole contact overlap portion 10ax. The first magnetic pole contact overlap portion 10ax overlaps an outer edge 31cr of the contact portion 31c in the first direction D1. The second magnetic pole edge portion 10b of the magnetic pole 10 includes a second magnetic pole contact overlap portion 10bx. The second magnetic pole contact overlap portion 10bx overlaps the outer edge 31cr of the contact portion 31c in the first direction D1.

The magnetic pole end portion 10e includes a first end 10ea and a second end 10eb. The direction that connects the first end 10ea and the second end 10eb is aligned with the second direction D2. The magnetic pole end portion center 10ec of the magnetic pole end portion 10e is positioned between the first end 10ea and the second end 10eb.

The distance between the first end 10ea and the first magnetic pole contact overlap portion 10ax is shorter than the distance between the first end 10ea and the second magnetic pole contact overlap portion 10bx. The distance between the second end 10eb and the second magnetic pole contact overlap portion 10bx is shorter than the distance between the second end 10eb and the first magnetic pole contact overlap portion 10ax.

A first line segment 10axL is a line segment connecting the first end 10ea and the first magnetic pole contact overlap portion 10ax. A first line segment direction 10axD is the direction of the first line segment 10axL. A second line segment 10bxL is a line segment connecting the second end 10eb and the second magnetic pole contact overlap portion 10bx. A second line segment direction 10bxD is the direction of the second line segment 10bxL.

On the other hand, the first coil edge portion 21a includes a first line segment overlap portion 21axc. The first line segment overlap portion 21axc overlaps the first line segment 10axL in the first direction D1. The first coil edge portion 21a includes a first overlap extension portion 21axe. The first overlap extension portion 21axe includes the first line segment overlap portion 21axc. The first overlap extension portion 21axe is aligned with a first overlap extension direction 21axD.

On the other hand, the second coil edge portion 21b includes a second line segment overlap portion 21bxc. The second line segment overlap portion 21bxc overlaps the second line segment 10bxL in the first direction D1. The second coil edge portion 21b includes a second overlap extension portion 21bxe. The second overlap extension portion 21bxe includes the second line segment overlap portion 21bxc. The second overlap extension portion 21bxe is aligned with a second overlap extension direction 21bxD.

A first angle θ1 is the absolute value of the angle between the first line segment direction 10axD and the first overlap extension direction 21axD. A second angle θ2 is the absolute value of the angle between the second line segment direction 10bxD and the second overlap extension direction 21bxD.

These angles are parameters relating to the relationship between the direction Dm2 of the magnetic field based on the current 20i and the direction in which the flux concentrates in the magnetic pole 10. In the embodiment, these angles can be set to be large. In the embodiment, for example, at least one of the first angle θ1 or the second angle θ2 is greater than 45 degrees.

In the example of the magnetic head 111, the first angle θ1 corresponds to the first crossing angle θs1 (referring to FIG. 1C). The second angle θ2 corresponds to the second crossing angle θs2 (referring to FIG. 1D).

In the magnetic head 112 shown in FIG. 5B as well, the first line segment direction 10axD of the first line segment 10axL and the second line segment direction 10bxD of the second line segment 10bxL are determined similarly to the magnetic head 111. In the magnetic head 112 as well, for example, at least one of the first angle θ1 or the second angle θ2 is greater than 45 degrees.

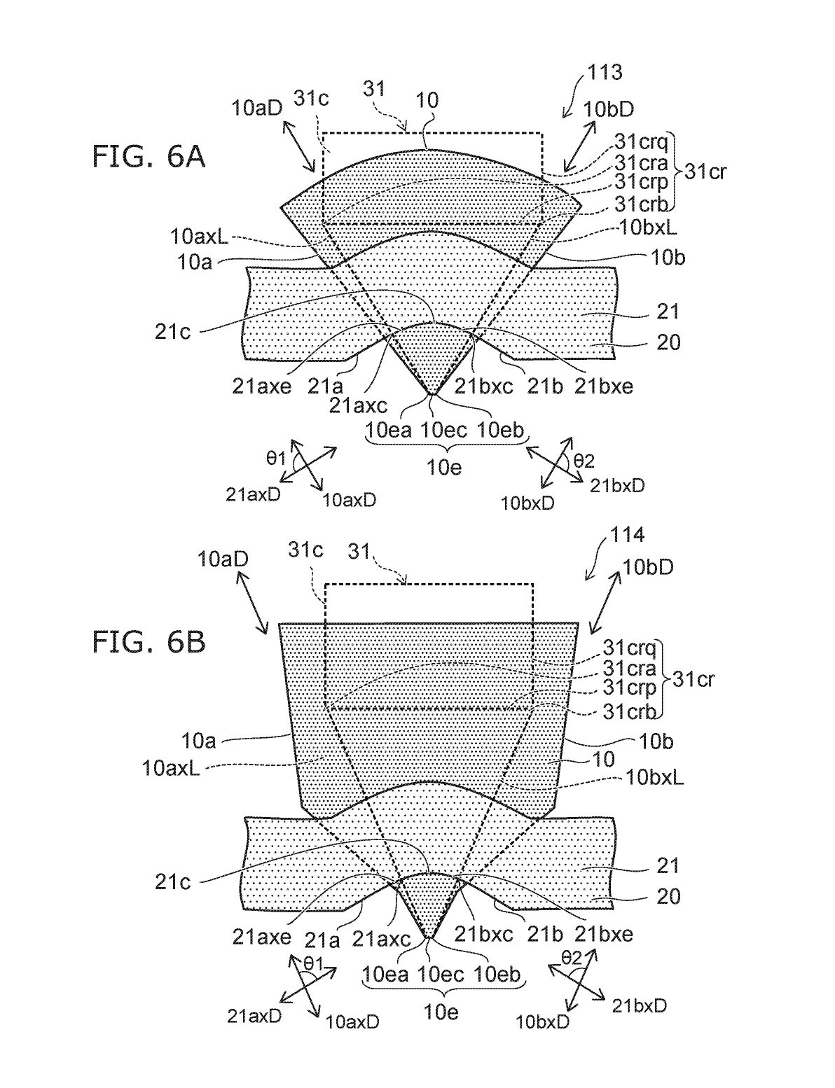

FIG. 6A and FIG. 6B are schematic perspective views illustrating other magnetic heads according to the first embodiment.

In these drawings, the contact portion 31c of the first shield 31 (referring to FIG. 2A), the magnetic pole 10, and the first coil portion 21 are drawn; and the other components are not illustrated.

As shown in FIG. 6A and FIG. 6B, the magnetic head 113 and the magnetic head 114 according to the embodiment include the first shield 31 including the contact portion 31c. The contact portion 31c contacts a portion of the magnetic pole 10. In these examples, the width (the length along the X-axis direction) of the contact portion 31c is narrower than the width of the magnetic pole 10.

As shown in FIG. 6A, the outer edge 31cr of the contact portion 31c includes a first corner end portion 31cra, a second corner end portion 31crb, a first connecting edge portion 31crp, and a second connecting edge portion 31crq. The first connecting edge portion 31crp connects the first corner end portion 31cra and the second corner end portion 31crb. The second connecting edge portion 31crq also connects the first corner end portion 31cra and the second corner end portion 31crb. For example, the direction that connects the first corner end portion 31cra and the second corner end portion 31crb is aligned with the second direction D2. The first connecting edge portion 31crp is positioned between the second connecting edge portion 31crq and the magnetic pole end portion 10e in the third direction D3. The first connecting edge portion 31crp is the side portion on the lower side of the contact portion 31c. The second connecting edge portion 31crq includes the side portion on the upper side of the contact portion 31c. The first corner end portion 31cra and the second corner end portion 31crb correspond to two ends of the edge portion of the lower end of the contact portion 31c.

The magnetic pole end portion 10e of the magnetic pole 10 includes the first end 10ea and the second end 10eb. The direction that connects the first end 10ea and the second end 10eb is aligned with the second direction D2. The magnetic pole end portion center 10ec is positioned between the first end 10ea and the second end 10eb.

The distance between the first end 10ea and the first corner end portion 31cra is shorter than the distance between the first end 10ea and the second corner end portion 31crb. The distance between the second end 10eb and the second corner end portion 31crb is shorter than the distance between the second end 10eb and the first corner end portion 31cra.

The first line segment 10axL is a line segment connecting the first end 10ea and the first corner end portion 31cra. The first line segment direction 10axD is the direction of the first line segment 10axL. The second line segment 10bxL is a line segment connecting the second end 10eb and the second corner end portion 31crb. The second line segment direction 10bxD is the direction of the second line segment 10bxL.

On the other hand, the first coil edge portion 21a includes the first line segment overlap portion 21axc. The first line segment overlap portion 21axc overlaps the first line segment 10axL in the first direction D1. The first coil edge portion 21a includes the first overlap extension portion 21axe. The first overlap extension portion 21axe includes the first line segment overlap portion 21axc. The first overlap extension portion 21axe is aligned with the first overlap extension direction 21axD.

On the other hand, the second coil edge portion 21b includes the second line segment overlap portion 21bxc. The second line segment overlap portion 21bxc overlaps the second line segment 10bxL in the first direction D1. The second coil edge portion 21b includes the second overlap extension portion 21bxe. The second overlap extension portion 21bxe includes the second line segment overlap portion 21bxc. The second overlap extension portion 21bxe is aligned with the second overlap extension direction 21bxD.

In the embodiment, the absolute value of the angle between the first line segment direction 10axD and the first overlap extension direction 21axD (the first angle θ1) is large. The absolute value of the angle between the second line segment direction 10bxD and the second overlap extension direction 21bxD (the second angle θ2) is large. For example, at least one of the first angle θ1 or the second angle θ2 is greater than 45 degrees.

In the magnetic head 114 shown in FIG. 6B as well, the first line segment direction 10axD of the first line segment 10axL and the second line segment direction 10bxD of the second line segment 10bxL are determined similarly to the magnetic head 113. In the magnetic head 114 as well, for example, at least one of the first angle θ1 or the second angle θ2 is greater than 45 degrees.

An example of the characteristics of the magnetic head will now be described in which the first angle θ1 described in reference to FIG. 5A to FIG. 6B is changed. In the following example, the second angle θ2 is the same as the first angle θ1.

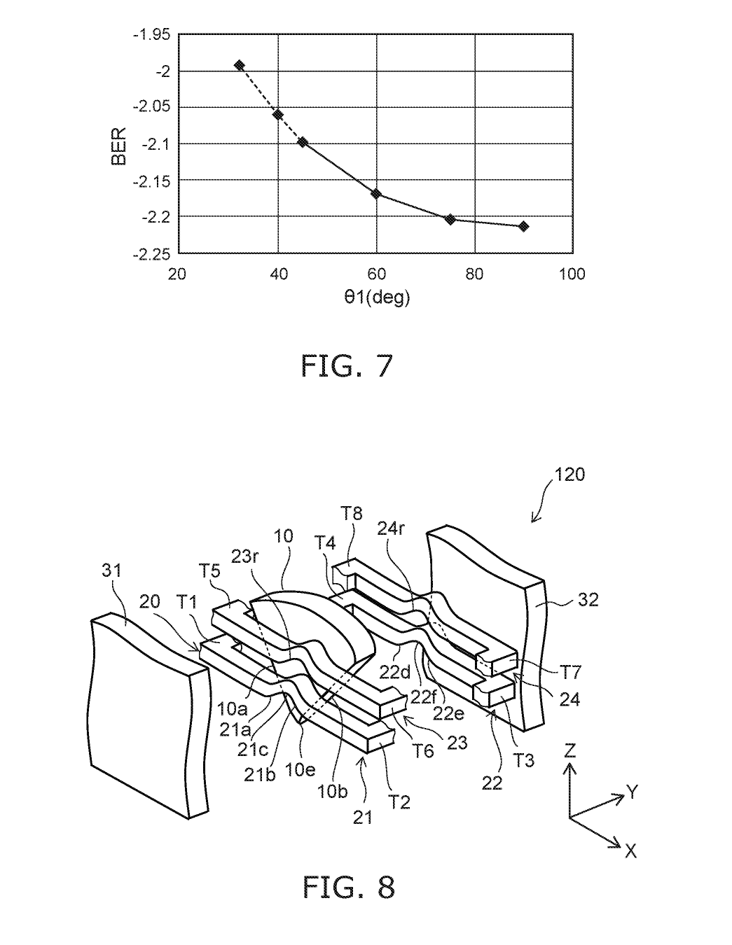

FIG. 7 is a graph illustrating a characteristic of the magnetic head.

The horizontal axis of FIG. 7 is the first angle θ1 (degrees). The vertical axis is a bit error rate BER. In the example, the bit error rate BER occurring when the transfer speed is 3 Gbps is shown. The transfer speed of 3 Gbps corresponds to a linear recording density of 1250 kBPI. A small bit error rate BER (the absolute value of a negative value being large) corresponds to good characteristics.

It can be seen from FIG. 7 that the bit error rate BER decreases as the first angle θ1 (or the second angle θ2) increases. It is considered that this is because, as described in reference to FIG. 3A to FIG. 3C, the angle between the direction in which the flux concentrates in the magnetic pole 10 and the direction Dm2 of the magnetic field generated by the current 20i decreases as the first angle θ1 increases. By setting the first angle θ1 to be large, the response of the magnetic field generated in the magnetic pole 10 can be improved.

For example, in the magnetic head 119b of the second reference example, the first angle θ1 corresponds to about 35 degrees. In the magnetic head 119a of the first reference example, the first angle θ1 corresponds to about 45 degrees.

In the embodiment, the first angle θ1 can be greater than 45 degrees. Thereby, a good bit error rate BER is obtained.

In the case of a configuration such as the magnetic head 111 (referring to FIG. 5A), the first crossing angle θs1 may be used as the first angle θ1 recited above. The second crossing angle θs2 may be used as the second angle θ2 recited above.

An example of the second coil portion 22 provided in the coil 20 will now be described with reference to FIG. 1A and FIG. 2B.

The coil 20 includes the second coil portion 22. The second coil portion 22 is electrically connected to the first coil portion 21. At least a portion of the magnetic pole 10 is disposed between at least a portion of the first coil portion 21 and at least a portion of the second coil portion 22 in the first direction D1 (e.g., the Y-axis direction).

The second coil portion 22 includes a fourth coil edge portion 22d, a fifth coil edge portion 22e, and a sixth coil edge portion 22f. The sixth coil edge portion 22f is connected to the fourth coil edge portion 22d and the fifth coil edge portion 22e. The sixth coil edge portion 22f overlaps the magnetic pole 10 in the first direction D1.

As shown in FIG. 1A and FIG. 2B, a third straight line L3 is a straight line parallel to the first straight line L1 and passing through the sixth coil edge portion 22f. As shown in FIG. 2B, a fifth distance d5 is the distance along the second direction D2 between the third straight line L3 and the fourth coil edge portion 22d. The fifth distance d5 decreases along the third direction D3. A sixth distance d6 is the distance along the second direction D2 between the third straight line L3 and the fifth coil edge portion 22e. The sixth distance d6 decreases along the third direction D3.

Thereby, in the second coil portion 22 as well, the direction of the magnetic field generated by the current 20i is aligned with the direction in which the flux concentrates in the magnetic pole 10. Thereby, the response of the magnetic field generated in the magnetic pole 10 can be improved.

The position in the third direction D3 of the fourth coil edge portion 22d is between the position in the third direction D3 of the sixth coil edge portion 22f and the position in the third direction D3 of the magnetic pole end portion 10e. The position in the third direction D3 of the fifth coil edge portion 22e is between the position in the third direction D3 of the sixth coil edge portion 22f and the position in the third direction D3 of the magnetic pole end portion 10e.

FIG. 8 is a schematic perspective view illustrating another magnetic head according to the first embodiment.

For easier viewing of the drawing in FIG. 8, the components are drawn as being separated from each other; and some of the components such as the insulating portions, etc., are not illustrated.

As shown in FIG. 8, the magnetic pole 10 and the coil 20 are provided in the magnetic head 120 as well. In the magnetic head 120, the coil 20 includes a third coil portion 23 and a fourth coil portion 24 in addition to the first coil portion 21 and the second coil portion 22. Otherwise, the magnetic head 120 is similar to the magnetic head 110. The coil 20 of the magnetic head 120 will now be described.

The third coil portion 23 is electrically connected to the first coil portion 21. The third coil portion 23 may be electrically connected to the second coil portion 22. The third coil portion 23 is separated from the magnetic pole 10 in the first direction D1. The direction that connects the first coil portion 21 and the third coil portion 23 is aligned with the third direction D3. For example, at least a portion of the third coil portion 23 is positioned on the first coil portion 21. At least a portion of an edge portion 23r of the third coil portion 23 is aligned with the first coil edge portion 21a, the second coil edge portion 21b, and the third coil edge portion 21c.

For example, the fourth coil portion 24 is electrically connected to the third coil portion 23. For example, at least a portion of the magnetic pole is disposed between the fourth coil portion 24 and at least a portion of the third coil portion 23 in the first direction D1. At least a portion of an edge portion 24r of the fourth coil portion 24 is aligned with the fourth coil edge portion 22d, the fifth coil edge portion 22e, and the sixth coil edge portion 22f.

For example, the second coil end T2 of the first coil portion 21 is connected to the third coil end T3 of the second coil portion 22. The fourth coil end T4 of the second coil portion 22 is connected to a fifth coil end T5 of the third coil portion 23. A sixth coil end T6 of the third coil portion 23 is connected to a seventh coil end T7 of the fourth coil portion 24. For example, the first coil end T1 of the first coil portion 21 and an eighth coil end T8 of the fourth coil portion 24 are terminals for supplying the current 20i.

In the magnetic head 120 as well, a magnetic head and a magnetic recording and reproducing device can be provided in which the transfer speed can be increased.

In the magnetic head 120, for example, a portion of the magnetic pole 10 is positioned between at least a portion of the first coil portion 21 and at least a portion of the second coil portion 22 in the first direction D1. Another portion of the magnetic pole 10 is positioned between at least a portion of the third coil portion 23 and at least a portion of the fourth coil portion 24 in the first direction D1. In the example, the direction from the first coil portion 21 toward the third coil portion 23 is aligned with the third direction D3. In the example, the direction from the second coil portion 22 toward the fourth coil portion 24 is aligned with the third direction D3.

A portion of the second coil portion 22 is connected to a portion of the first coil portion 21. A portion of the third coil portion 23 is connected to another portion of the second coil portion 22. A portion of the fourth coil portion 24 is connected to another portion of the third coil portion 23.

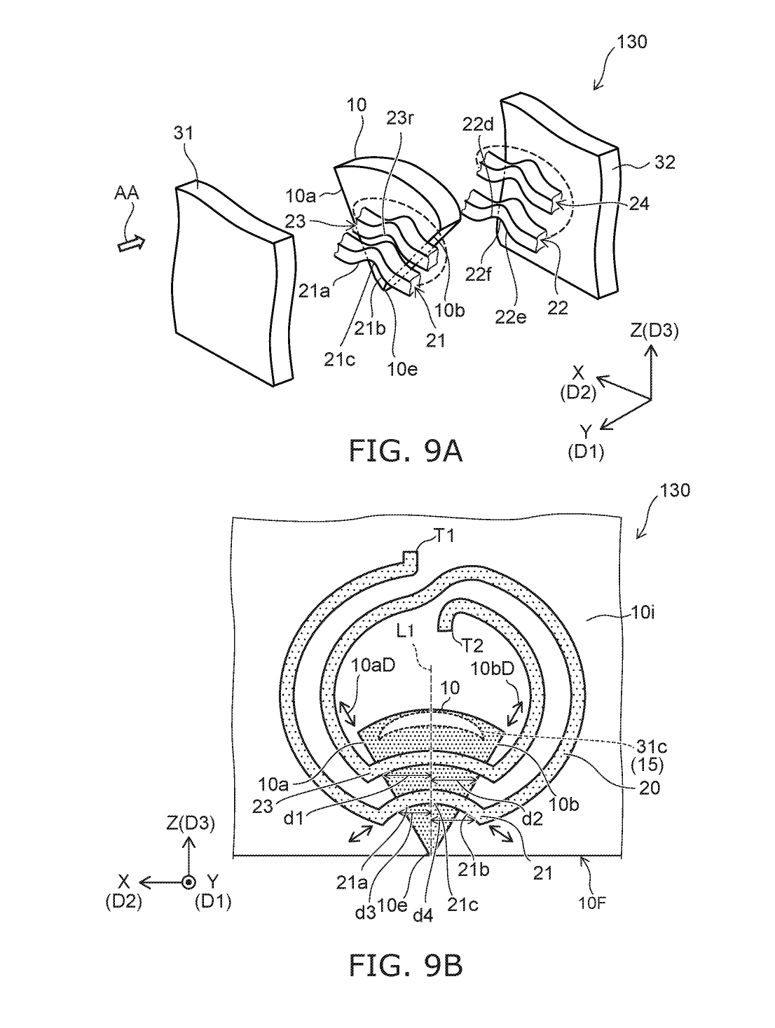

FIG. 9A and FIG. 9B are schematic views illustrating another magnetic head according to the first embodiment.

FIG. 9A is a perspective view. FIG. 9B is a perspective side view as viewed along arrow direction AA shown in FIG. 9A. A portion of the components are not illustrated in FIG. 9B. For easier viewing of the drawing in FIG. 9A, the components are drawn as being separated.

As shown in FIG. 9A, the magnetic head 130 according to the embodiment also includes the magnetic pole 10 and the coil 20. The first shield 31 and the second shield 32 are provided in the magnetic head 130 as well. In the magnetic head 130, the configuration of the coil 20 is different from that of the magnetic head 110.

As shown in FIG. 9B, the coil 20 is a double-wound pancake-type. The coil 20 further includes the second coil portion 22, the third coil portion 23, and the fourth coil portion 24 in addition to the first coil portion 21.

The magnetic pole 10 is positioned between a group including the first coil portion 21 and the third coil portion 23 and a group including the second coil portion 22 and the fourth coil portion 24. The direction from the first coil portion 21 toward the third coil portion 23 is aligned with the third direction D3. The direction from the second coil portion 22 toward the fourth coil portion 24 is aligned with the third direction D3. For example, the third coil portion 23 is above the first coil portion 21. For example, the fourth coil portion 24 is above the second coil portion 22.

For example, a portion of the third coil portion 23 is connected to a portion of the first coil portion 21. Another portion of the third coil portion 23 is connected to a portion of one of the second coil portion 22 or the fourth coil portion 24. Another portion of the one of the second coil portion 22 or the fourth coil portion 24 recited above is connected to a portion of the other of the second coil portion 22 or the fourth coil portion 24.

At least a portion of the edge portion 23r of the third coil portion 23 is aligned with the first coil edge portion 21a, the second coil edge portion 21b, and the third coil edge portion 21c. At least a portion of the edge portion 24r of the fourth coil portion 24 is aligned with the fourth coil edge portion 22d, the fifth coil edge portion 22e, and the sixth coil edge portion 22f.

In the magnetic head 130 as well, a magnetic head and a magnetic recording and reproducing device can be provided in which the transfer speed can be increased.

In the example shown in FIG. 9B, the magnetic pole 10 has a hole 15 that communicates with the contact portion 31c. For example, the hole 15 that communicates with the contact portion 31c pierces the magnetic pole 10 in the first direction D1 (the Y-axis direction).

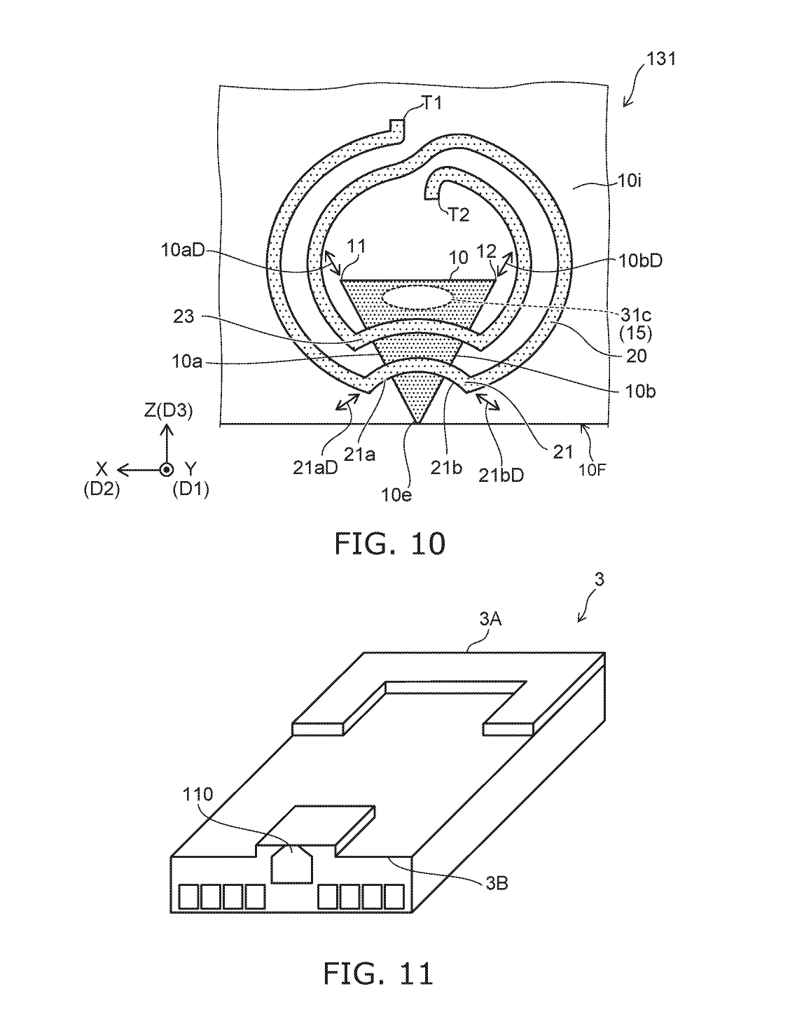

FIG. 10 is a schematic side view illustrating another magnetic head according to the first embodiment.

FIG. 10 is a side view corresponding to FIG. 9B.

As shown in FIG. 10, the magnetic head 131 according to the embodiment also includes the magnetic pole 10 and the coil 20. The configuration of the coil 20 of the magnetic head 131 is similar to that of the magnetic head 130. In the magnetic head 131, the upper end of the magnetic pole 10 is flat.

For example, the magnetic pole 10 includes a first end portion 11 and a second end portion 12. These end portions are the end portions on the upper side. For example, a direction that connects the first end portion 11 and the second end portion 12 is aligned with the second direction D2. The magnetic pole 10 includes a side portion 14 connecting the first end portion 11 and the second end portion 12. The side portion 14 extends along the second direction D2. For example, the side portion 14 is substantially parallel to the second direction D2. Otherwise, the magnetic head 131 is similar to the magnetic head 130.

In the magnetic head 131 as well, a magnetic head and a magnetic recording and reproducing device can be provided in which the transfer speed can be increased.

As illustrated in FIG. 5A, FIG. 5B, FIG. 6A, FIG. 6B, FIG. 9B, FIG. 10, etc., the configuration in the X-Z plane of the contact portion 31c (or the hole 15 communicating with the contact portion 31c) may be a polygon (e.g., a quadrilateral, etc.), a circle (including a flattened circle), a crescent shape, etc.

### Second Embodiment

A second embodiment relates to a magnetic memory device. The magnetic memory device according to the embodiment includes a magnetic head and the magnetic recording medium 80. Information is recorded in the magnetic recording medium 80 by the magnetic pole 10. The magnetic head is any magnetic head according to the first embodiment or a magnetic head of a modification of the first embodiment. The case where the magnetic head 110 is used will now be described.

FIG. 11 is a schematic perspective view illustrating a portion of a magnetic recording and reproducing device according to the second embodiment.

FIG. 11 illustrates a head slider.

The magnetic head 110 is provided in a head slider 3. The head slider 3 includes, for example, Al₂O₃/TiC, etc. The head slider 3 moves relative to the magnetic recording medium 80 while flying over or contacting the magnetic recording medium 80.

The head slider 3 has, for example, an air inflow side 3A and an air outflow side 3B. The magnetic head 110 is disposed at the side surface of the air outflow side 3B of the head slider 3 or the like. Thereby, the magnetic head 110 moves relative to the magnetic recording medium 80 while flying over or contacting the magnetic recording medium 80.

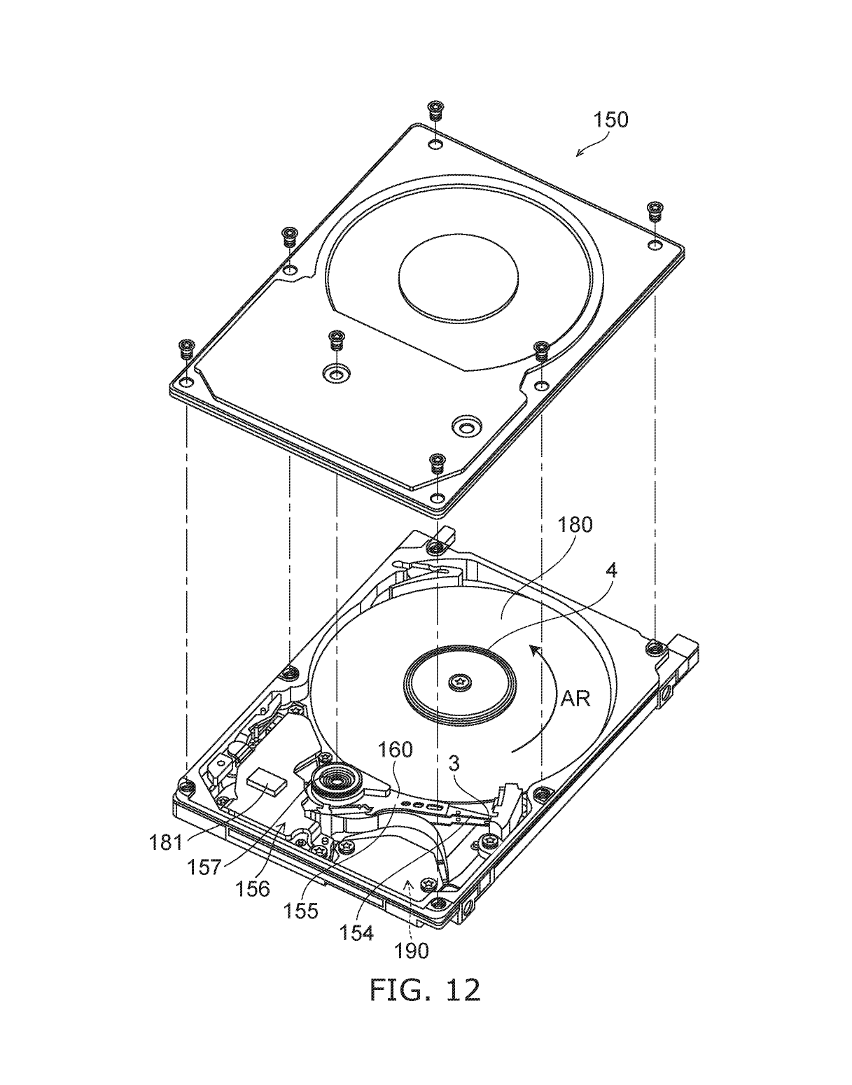

FIG. 12 is a schematic perspective view illustrating the magnetic recording and reproducing device according to the second embodiment.

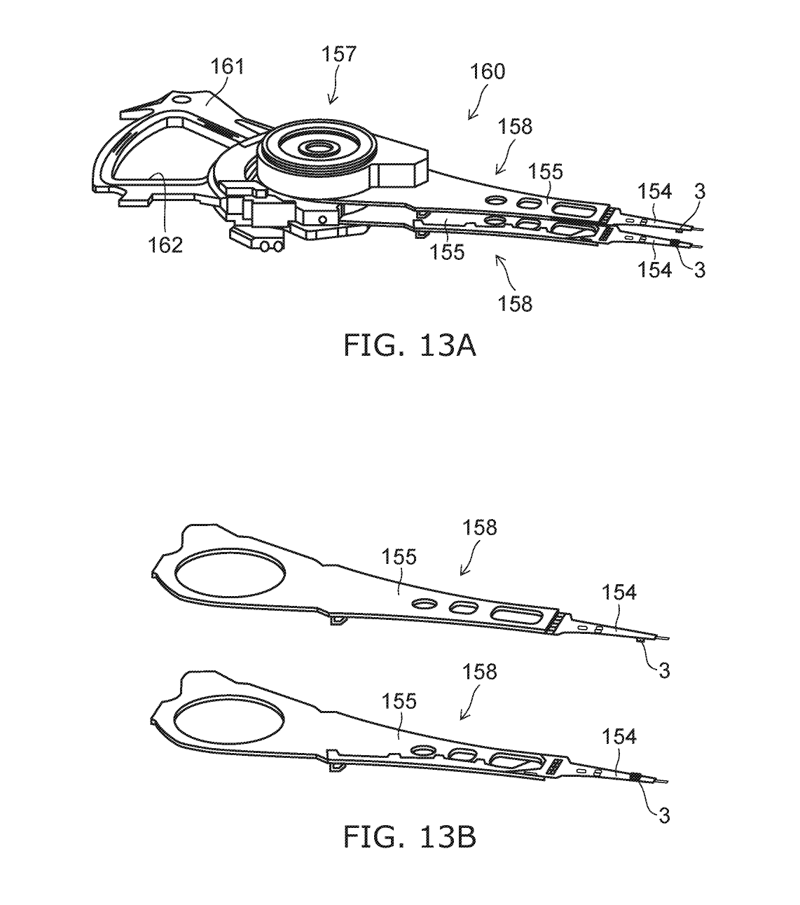

FIG. 13A and FIG. 13B are schematic perspective views illustrating portions of the magnetic recording and reproducing device according to the second embodiment.

As shown in FIG. 12, a rotary actuator is used in the magnetic recording and reproducing device 150 according to the embodiment. A recording medium disk 180 is mounted to a spindle motor 4. The recording medium disk 180 is rotated in the direction of arrow AR by a motor. The motor responds to a control signal from a drive device controller. The magnetic recording and reproducing device 150 according to the embodiment may include multiple recording medium disks 180. The magnetic recording and reproducing device 150 may include a recording medium 181. The recording medium 181 is, for example, a SSD (Solid State Drive). The recording medium 181 includes, for example, nonvolatile memory such as flash memory, etc. For example, the magnetic recording and reproducing device 150 may be a hybrid HDD (Hard Disk Drive).

The head slider 3 performs the recording and reproducing of the information recorded in the recording medium disk 180. The head slider 3 is provided at the tip of a suspension 154 having a thin-film configuration. Any of the magnetic heads according to the embodiments is provided at the tip vicinity of the head slider 3.

When the recording medium disk 180 rotates, the downward pressure due to the suspension 154 and the pressure generated at the medium-opposing surface (the ABS) of the head slider 3 are balanced. The distance between the medium-opposing surface of the head slider 3 and the surface of the recording medium disk 180 is a prescribed fly height. In the embodiment, the head slider 3 may contact the recording medium disk 180. For example, contact-sliding is applicable.

The suspension 154 is connected to one end of an arm 155 (e.g., an actuator arm). The arm 155 includes, for example, a bobbin unit, etc. The bobbin unit holds a drive coil. A voice coil motor 156 is provided at the other end of the arm 155. The voice coil motor 156 is one type of linear motor. The voice coil motor 156 includes, for example, a drive coil and a magnetic circuit. The drive coil is wound onto the bobbin unit of the arm 155. The magnetic circuit includes a permanent magnet and an opposing yoke. The drive coil is provided between the permanent magnet and the opposing yoke. The suspension 154 has one end and another end. The magnetic head is provided at the one end of the suspension 154. The arm 155 is connected to the other end of the suspension 154.

The arm 155 is held by ball bearings. The ball bearings are provided at two locations above and below a bearing unit 157. The arm 155 can be caused to rotate and slide by the voice coil motor 156. The magnetic head is movable to any position of the recording medium disk 180.

FIG. 13A illustrates the configuration of a portion of the magnetic recording and reproducing device and is an enlarged perspective view of a head stack assembly 160.

FIG. 13B is a perspective view illustrating a magnetic head assembly (a head gimbal assembly (HGA)) 158 which is a portion of the head stack assembly 160.

As shown in FIG. 13A, the head stack assembly 160 includes the bearing unit 157, the head gimbal assembly 158, and a support frame 161. The head gimbal assembly 158 extends from the bearing unit 157. The support frame 161 extends from the bearing unit 157. The direction in which the support frame 161 extends is the reverse of the direction in which the head gimbal assembly 158 extends. The support frame 161 supports a coil 162 of the voice coil motor.

As shown in FIG. 13B, the head gimbal assembly 158 includes the arm 155 that extends from the bearing unit 157, and the suspension 154 that extends from the arm 155.

The head slider 3 is provided at the tip of the suspension 154. Any of the magnetic heads according to the embodiments is provided in the head slider 3.

The magnetic head assembly (the head gimbal assembly) 158 according to the embodiment includes the magnetic head according to the embodiment, the head slider 3 in which the magnetic head is provided, the suspension 154, and the arm 155. The head slider 3 is provided at the one end of the suspension 154. The arm 155 is connected to the other end of the suspension 154.

The suspension 154 includes, for example, lead wires (not illustrated) for recording and reproducing signals. The suspension 154 may include, for example, lead wires (not illustrated) for a heater for fly height adjustment. The suspension 154 may include, for example, lead wires (not illustrated) for a spin torque oscillator, etc. These lead wires are electrically connected to multiple electrodes provided in the magnetic head.

A signal processor 190 is provided in the magnetic recording and reproducing device 150. The signal processor 190 performs recording and reproducing of the signals to and from the magnetic recording medium by using the magnetic head. The signal processor 190 is electrically connected to the magnetic head by the input/output lines of the signal processor 190 being connected to, for example, electrode pads of the head gimbal assembly 158.

The magnetic recording and reproducing device 150 according to the embodiment includes a magnetic recording medium, the magnetic head according to the embodiment, a movable unit, a position controller, and a signal processor. The movable unit is relatively movable in a state in which the magnetic recording medium and the magnetic head are separated from each other or in contact with each other. The position controller aligns the magnetic head at a prescribed recording position of the magnetic recording medium. The signal processor performs recording and reproducing of the signals to and from the magnetic recording medium by using the magnetic head.

For example, the recording medium disk 180 is used as the magnetic recording medium recited above. The movable unit recited above includes, for example, the head slider 3. The position controller recited above includes, for example, the head gimbal assembly 158.

The magnetic recording and reproducing device 150 according to the embodiment includes the magnetic recording medium, the magnetic head assembly according to the embodiment, and the signal processor that performs recording and reproducing of the signals to and from the magnetic recording medium by using the magnetic head provided in the magnetic head assembly.

According to the embodiment, a magnetic head and a magnetic recording and reproducing device can be provided in which the transfer speed can be increased.

The embodiments include the following configurations.

### (Configuration 1)

A magnetic head, comprising:

a magnetic pole; and

a coil including a first coil portion, the first coil portion being separated from the magnetic pole in a first direction,

the magnetic pole including
a magnetic pole end portion,
a first magnetic pole edge portion connected to the magnetic pole end portion, and
a second magnetic pole edge portion connected to the magnetic pole end portion,

the first coil portion including
a first coil edge portion,
a second coil edge portion, and
a third coil edge portion overlapping the magnetic pole in the first direction and being connected to the first coil edge portion and the second coil edge portion,

the first magnetic pole edge portion including a first magnetic pole overlap portion overlapping the first coil edge portion in the first direction,

the second magnetic pole edge portion including a second magnetic pole overlap portion overlapping the second coil edge portion in the first direction,

the magnetic pole end portion having a magnetic pole end portion center in a second direction, the second direction connecting the first magnetic pole overlap portion and the second magnetic pole overlap portion,

a distance in the second direction between the first magnetic pole edge portion and a first straight line increasing along a third direction, the third direction being from the magnetic pole end portion center toward the overlap portion center, the first straight line connecting the magnetic pole end portion center and an overlap portion center, the overlap portion center being between the first magnetic pole overlap portion and the second magnetic pole overlap portion,

a distance in the second direction between the first coil edge portion and a second straight line decreasing along the third direction, the second straight line passing through the third coil edge portion and being parallel to the first straight line.

### (Configuration 2)

The magnetic head according to configuration 1, wherein

a distance in the second direction between the first straight line and the second magnetic pole edge portion increases along the third direction, and

a distance in the second direction between the second straight line and the second coil edge portion decreases along the third direction.

### (Configuration 3)

The magnetic head according to configuration 2, wherein

the second magnetic pole edge portion includes a second magnetic pole extension portion including the second magnetic pole overlap portion and being aligned with the second magnetic pole extension direction,

the second coil edge portion includes a second coil overlap portion overlapping the second magnetic pole edge portion in the first direction,

the second coil edge portion includes a second coil extension portion, the second coil extension portion including the second coil overlap portion and being aligned with the second coil extension direction, and

an absolute value of an angle between the second magnetic pole extension direction and the second coil extension direction is greater than 45 degrees.

### (Configuration 4)

The magnetic head according to one of configurations 1 to 3, wherein

the first magnetic pole edge portion includes a first magnetic pole extension portion including the first magnetic pole overlap portion and being aligned with the first magnetic pole extension direction,

the first coil edge portion includes a first coil overlap portion overlapping the first magnetic pole edge portion in the first direction,

the first coil edge portion includes a first coil extension portion, the first coil extension portion including the first coil overlap portion and being aligned with the first coil extension direction, and

an absolute value of an angle between the first magnetic pole extension direction and the first coil extension direction is greater than 45 degrees.

### (Configuration 5)

The magnetic head according to configuration 1 or 2, further comprising a first shield including a contact portion, the contact portion contacting a portion of the magnetic pole,

the first magnetic pole edge portion including a first magnetic pole contact overlap portion overlapping an outer edge of the contact portion in the first direction,

the second magnetic pole edge portion including a second magnetic pole contact overlap portion overlapping an outer edge of the contact portion in the first direction,

the magnetic pole end portion further including a first end and a second end, a direction connecting the first end and the second end and being aligned with the second direction, the magnetic pole end portion center being positioned between the first end and the second end,

a distance between the first end and the first magnetic pole contact overlap portion being shorter than a distance between the first end and the second magnetic pole contact overlap portion,

a distance between the second end and the second magnetic pole contact overlap portion being shorter than a distance between the second end and the first magnetic pole contact overlap portion,

the first coil edge portion including a first line segment overlap portion overlapping a first line segment in the first direction, the first line segment connecting the first end and the first magnetic pole contact overlap portion,

the first coil edge portion including a first overlap extension portion, the first overlap extension portion including the first line segment overlap portion and being aligned with a first overlap extension direction,

an absolute value of an angle between the first overlap extension direction and a direction of the first line segment being greater than 45 degrees.

### (Configuration 6)

The magnetic head according to configuration 5, wherein

the second coil edge portion includes a second line segment overlap portion overlapping a second line segment in the first direction, the second line segment connecting the second end and the second magnetic pole contact overlap portion,

the second coil edge portion includes a second overlap extension portion, the second overlap extension portion including the second line segment overlap portion and being aligned with a second overlap extension direction, and

an absolute value of an angle between the second overlap extension direction and a direction of the second line segment is greater than 45 degrees.

### (Configuration 7)

The magnetic head according to configuration 1 or 2, further comprising a first shield including a contact portion, the contact portion contacting a portion of the magnetic pole,

an outer edge of the contact portion including
a first corner end portion,
a second corner end portion,
a first connecting edge portion connecting the first corner end portion and the second corner end portion, and
a second connecting edge portion connecting the first corner end portion and the second corner end portion,

a direction connecting the first corner end portion and the second corner end portion and being aligned with the second direction,

the first connecting edge portion being positioned between the second connecting edge portion and the magnetic pole end portion in the third direction,

the magnetic pole end portion further including a first end and a second end, a direction connecting the first end and the second end is aligned with the second direction, the magnetic pole end portion center being positioned between the first end and the second end,

a distance between the first end and the first corner end portion being shorter than a distance between the first end and the second corner end portion,

a distance between the second end and the second corner end portion being shorter than a distance between the second end and the first corner end portion,

the first coil edge portion including a first line segment overlap portion overlapping a first line segment in the first direction, the first line segment connecting the first end and the first corner end portion,

the first coil edge portion including a first overlap extension portion, the first overlap extension portion including the first line segment overlap portion and being aligned with the first overlap extension direction,

an absolute value of an angle between the first overlap extension direction and a direction of the first line segment being greater than 45 degrees.

### (Configuration 8)

The magnetic head according to configuration 7, wherein

the second coil edge portion includes a second line segment overlap portion overlapping the second line segment in the first direction, the second line segment connecting the second end and the second magnetic pole contact overlap portion,

the second coil edge portion includes a second overlap extension portion, the second overlap extension portion including the second line segment overlap portion and being aligned with the second overlap extension direction, and

an absolute value of an angle between the second overlap extension direction and a direction of the second line segment is greater than 45 degrees.

### (Configuration 9)

The magnetic head according to one of configurations 1 to 8, wherein

a position in the third direction of the first coil edge portion is between a position in the third direction of the third coil edge portion and a position in the third direction of the magnetic pole end portion, and

a position in the third direction of the second coil edge portion is between the position in the third direction of the third coil edge portion and the position in the third direction of the magnetic pole end portion.

### (Configuration 10)

The magnetic head according to one of configurations 1 to 9, wherein

the coil further includes a second coil portion electrically connected to the first coil portion,

at least a portion of the magnetic pole is disposed between at least a portion of the first coil portion and at least a portion of the second coil portion in the first direction,

the second coil portion includes:
a fourth coil edge portion;
a fifth coil edge portion; and
a sixth coil edge portion overlapping the magnetic pole in the first direction and being connected to the fourth coil edge portion and the fifth coil edge portion, and

a distance in the second direction between the fourth coil edge portion and a third straight line decreases along the third direction, the third straight line passing through the sixth coil edge portion and being parallel to the first straight line.

### (Configuration 11)

The magnetic head according to configuration 10, wherein a distance in the second direction between the third straight line and the fifth coil edge portion decreases along the third direction.

### (Configuration 12)

The magnetic head according to configuration 10 or 11, wherein

a position in the third direction of the fourth coil edge portion is between a position in the third direction of the sixth coil edge portion and a position in the third direction of the magnetic pole end portion, and

a position in the third direction of the fifth coil edge portion is between the position in the third direction of the sixth coil edge portion and the position in the third direction of the magnetic pole end portion.

### (Configuration 13)

The magnetic head according to one of configurations 1 to 12, wherein

the coil further includes a third coil portion electrically connected to the first coil portion,

the third coil portion is separated from the magnetic pole in the first direction,

a direction connecting the first coil portion and the third coil portion is aligned with the third direction, and

at least a portion of an edge portion of the third coil portion is aligned with the first coil edge portion, the second coil edge portion, and the third coil edge portion.

### (Configuration 14)

The magnetic head according to configuration 13, wherein

the coil further includes a fourth coil portion electrically connected to the third coil portion, and

at least a portion of the magnetic pole is disposed between the fourth coil portion and at least a portion of the third coil portion.

### (Configuration 15)

The magnetic head according to one of configurations 1 to 9, wherein

the coil further includes a second coil portion, a third coil portion, and a fourth coil portion,

a portion of the magnetic pole is positioned between at least a portion of the first coil portion and at least a portion of the second coil portion in the first direction,

another portion of the magnetic pole is positioned between at least a portion of the third coil portion and at least a portion of the fourth coil portion in the first direction,

a direction from the first coil portion toward the third coil portion is aligned with the third direction,

a direction from the second coil portion toward the fourth coil portion is aligned with the third direction, a portion of the second coil portion is connected to a portion of the first coil portion,

a portion of the third coil portion is connected to another portion of the second coil portion, and

a portion of the fourth coil portion is connected to another portion of the third coil portion.

### (Configuration 16)

The magnetic head according to one of configurations 1 to 9, wherein

the coil further includes a second coil portion, a third coil portion, and a fourth coil portion,

the magnetic pole is positioned between a group including the first coil portion and the third coil portion and a group including the second coil portion and the fourth coil portion,

a direction from the first coil portion toward the third coil portion is aligned with the third direction,

a direction from the second coil portion toward the fourth coil portion is aligned with the third direction,

a portion of the third coil portion is connected to a portion of the first coil portion,

another portion of the third coil portion is connected to a portion of one of the second coil portion or the fourth coil portion, and

another portion of the one of the second coil portion or the fourth coil portion is connected to a portion of the other of the second coil portion or the fourth coil portion.

### (Configuration 17)

The magnetic head according to one of configurations 1 to 16, wherein the magnetic pole has a hole piercing the magnetic pole in the first direction.

### (Configuration 18)

A magnetic recording and reproducing device, comprising:

the magnetic head according to one of configurations 1 to 17; and

a magnetic recording medium, information being recorded in the magnetic recording medium by the magnetic pole.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads such as magnetic poles, coils, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic head and magnetic recording and reproducing devices practicable by an appropriate design modification by one skilled in the art based on the magnetic heads and magnetic producing and reproducing devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a magnetic pole; and
a coil including a first coil portion, the first coil portion being separated from the magnetic pole in a first direction,
the magnetic pole including
a magnetic pole end portion,
a first magnetic pole edge portion connected to the magnetic pole end portion, and
a second magnetic pole edge portion connected to the magnetic pole end portion,
the first coil portion including
a first coil edge portion,
a second coil edge portion, and
a third coil edge portion overlapping the magnetic pole in the first direction and being connected to the first coil edge portion and the second coil edge portion,
the first magnetic pole edge portion including a first magnetic pole overlap portion overlapping the first coil edge portion in the first direction,
the second magnetic pole edge portion including a second magnetic pole overlap portion overlapping the second coil edge portion in the first direction,
the magnetic pole end portion having a magnetic pole end portion center in a second direction, the second direction connecting the first magnetic pole overlap portion and the second magnetic pole overlap portion,
a distance in the second direction between the first magnetic pole edge portion and a first straight line increasing along a third direction, the third direction being from the magnetic pole end portion center toward the overlap portion center, the first straight line connecting the magnetic pole end portion center and an overlap portion center, the overlap portion center being between the first magnetic pole overlap portion and the second magnetic pole overlap portion,
a distance in the second direction between the first coil edge portion and a second straight line decreasing along the third direction, the second straight line passing through the third coil edge portion and being parallel to the first straight line.

2. The head according to claim 1, wherein
a distance in the second direction between the first straight line and the second magnetic pole edge portion increases along the third direction, and
a distance in the second direction between the second straight line and the second coil edge portion decreases along the third direction.

3. The head according to claim 2, wherein
the second magnetic pole edge portion includes a second magnetic pole extension portion including the second magnetic pole overlap portion and being aligned with the second magnetic pole extension direction,
the second coil edge portion includes a second coil overlap portion overlapping the second magnetic pole edge portion in the first direction,
the second coil edge portion includes a second coil extension portion, the second coil extension portion including the second coil overlap portion and being aligned with the second coil extension direction, and
an absolute value of an angle between the second magnetic pole extension direction and the second coil extension direction is greater than 45 degrees.

4. The head according to claim 1, wherein
the first magnetic pole edge portion includes a first magnetic pole extension portion including the first magnetic pole overlap portion and being aligned with the first magnetic pole extension direction,
the first coil edge portion includes a first coil overlap portion overlapping the first magnetic pole edge portion in the first direction,
the first coil edge portion includes a first coil extension portion, the first coil extension portion including the first coil overlap portion and being aligned with the first coil extension direction, and
an absolute value of an angle between the first magnetic pole extension direction and the first coil extension direction is greater than 45 degrees.

5. The head according to claim 1, further comprising a first shield including a contact portion, the contact portion contacting a portion of the magnetic pole,
the first magnetic pole edge portion including a first magnetic pole contact overlap portion overlapping an outer edge of the contact portion in the first direction,
the second magnetic pole edge portion including a second magnetic pole contact overlap portion overlapping an outer edge of the contact portion in the first direction,
the magnetic pole end portion further including a first end and a second end, a direction connecting the first end and the second end and being aligned with the second direction, the magnetic pole end portion center being positioned between the first end and the second end,
a distance between the first end and the first magnetic pole contact overlap portion being shorter than a distance between the first end and the second magnetic pole contact overlap portion,
a distance between the second end and the second magnetic pole contact overlap portion being shorter than a distance between the second end and the first magnetic pole contact overlap portion,
the first coil edge portion including a first line segment overlap portion overlapping a first line segment in the first direction, the first line segment connecting the first end and the first magnetic pole contact overlap portion,
the first coil edge portion including a first overlap extension portion, the first overlap extension portion including the first line segment overlap portion and being aligned with a first overlap extension direction,
an absolute value of an angle between the first overlap extension direction and a direction of the first line segment being greater than 45 degrees.

6. The head according to claim 5, wherein
the second coil edge portion includes a second line segment overlap portion overlapping a second line segment in the first direction, the second line segment connecting the second end and the second magnetic pole contact overlap portion,
the second coil edge portion includes a second overlap extension portion, the second overlap extension portion including the second line segment overlap portion and being aligned with a second overlap extension direction, and
an absolute value of an angle between the second overlap extension direction and a direction of the second line segment is greater than 45 degrees.

7. The head according to claim 1, further comprising a first shield including a contact portion, the contact portion contacting a portion of the magnetic pole,
an outer edge of the contact portion including
a first corner end portion,
a second corner end portion,
a first connecting edge portion connecting the first corner end portion and the second corner end portion, and
a second connecting edge portion connecting the first corner end portion and the second corner end portion,
a direction connecting the first corner end portion and the second corner end portion and being aligned with the second direction,
the first connecting edge portion being positioned between the second connecting edge portion and the magnetic pole end portion in the third direction,
the magnetic pole end portion further including a first end and a second end, a direction connecting the first end and the second end is aligned with the second direction, the magnetic pole end portion center being positioned between the first end and the second end,
a distance between the first end and the first corner end portion being shorter than a distance between the first end and the second corner end portion,
a distance between the second end and the second corner end portion being shorter than a distance between the second end and the first corner end portion,
the first coil edge portion including a first line segment overlap portion overlapping a first line segment in the first direction, the first line segment connecting the first end and the first corner end portion,
the first coil edge portion including a first overlap extension portion, the first overlap extension portion including the first line segment overlap portion and being aligned with the first overlap extension direction,
an absolute value of an angle between the first overlap extension direction and a direction of the first line segment being greater than 45 degrees.

8. The head according to claim 7, wherein
the second coil edge portion includes a second line segment overlap portion overlapping the second line segment in the first direction, the second line segment connecting the second end and the second magnetic pole contact overlap portion,
the second coil edge portion includes a second overlap extension portion, the second overlap extension portion including the second line segment overlap portion and being aligned with the second overlap extension direction, and
an absolute value of an angle between the second overlap extension direction and a direction of the second line segment is greater than 45 degrees.

9. The head according to claim 1, wherein
a position in the third direction of the first coil edge portion is between a position in the third direction of the third coil edge portion and a position in the third direction of the magnetic pole end portion, and
a position in the third direction of the second coil edge portion is between the position in the third direction of the third coil edge portion and the position in the third direction of the magnetic pole end portion.

10. The head according to claim 1, wherein
the coil further includes a second coil portion electrically connected to the first coil portion,
at least a portion of the magnetic pole is disposed between at least a portion of the first coil portion and at least a portion of the second coil portion in the first direction,
the second coil portion includes:
a fourth coil edge portion;
a fifth coil edge portion; and
a sixth coil edge portion overlapping the magnetic pole in the first direction and being connected to the fourth coil edge portion and the fifth coil edge portion, and
a distance in the second direction between the fourth coil edge portion and a third straight line decreases along the third direction, the third straight line passing through the sixth coil edge portion and being parallel to the first straight line.

11. The head according to claim 10, wherein a distance in the second direction between the third straight line and the fifth coil edge portion decreases along the third direction.

12. The magnetic head according to claim 10, wherein
a position in the third direction of the fourth coil edge portion is between a position in the third direction of the sixth coil edge portion and a position in the third direction of the magnetic pole end portion, and
a position in the third direction of the fifth coil edge portion is between the position in the third direction of the sixth coil edge portion and the position in the third direction of the magnetic pole end portion.

13. The head according to claim 1, wherein
the coil further includes a third coil portion electrically connected to the first coil portion,
the third coil portion is separated from the magnetic pole in the first direction,
a direction connecting the first coil portion and the third coil portion is aligned with the third direction, and
at least a portion of an edge portion of the third coil portion is aligned with the first coil edge portion, the second coil edge portion, and the third coil edge portion.

14. The head according to claim 13, wherein
the coil further includes a fourth coil portion electrically connected to the third coil portion, and
at least a portion of the magnetic pole is disposed between the fourth coil portion and at least a portion of the third coil portion.

15. The head according to claim 1, wherein
the coil further includes a second coil portion, a third coil portion, and a fourth coil portion,
a portion of the magnetic pole is positioned between at least a portion of the first coil portion and at least a portion of the second coil portion in the first direction,
another portion of the magnetic pole is positioned between at least a portion of the third coil portion and at least a portion of the fourth coil portion in the first direction,
a direction from the first coil portion toward the third coil portion is aligned with the third direction,
a direction from the second coil portion toward the fourth coil portion is aligned with the third direction, a portion of the second coil portion is connected to a portion of the first coil portion,
a portion of the third coil portion is connected to another portion of the second coil portion, and
a portion of the fourth coil portion is connected to another portion of the third coil portion.

16. The head according to claim 1, wherein
the coil further includes a second coil portion, a third coil portion, and a fourth coil portion,
the magnetic pole is positioned between a group including the first coil portion and the third coil portion and a group including the second coil portion and the fourth coil portion,
a direction from the first coil portion toward the third coil portion is aligned with the third direction,
a direction from the second coil portion toward the fourth coil portion is aligned with the third direction,
a portion of the third coil portion is connected to a portion of the first coil portion,
another portion of the third coil portion is connected to a portion of one of the second coil portion or the fourth coil portion, and
another portion of the one of the second coil portion or the fourth coil portion is connected to a portion of the other of the second coil portion or the fourth coil portion.

17. The head according to claim 1, wherein the magnetic pole has a hole piercing the magnetic pole in the first direction.

18. A magnetic recording and reproducing device, comprising:
a magnetic head; and
a magnetic recording medium, information being recorded in the magnetic recording medium by the magnetic pole
the head including:
a magnetic pole; and
a coil including a first coil portion, the first coil portion being separated from the magnetic pole in a first direction,
the magnetic pole including
a magnetic pole end portion,
a first magnetic pole edge portion connected to the magnetic pole end portion, and
a second magnetic pole edge portion connected to the magnetic pole end portion,
the first coil portion including
a first coil edge portion,
a second coil edge portion, and
a third coil edge portion overlapping the magnetic pole in the first direction and being connected to the first coil edge portion and the second coil edge portion,
the first magnetic pole edge portion including a first magnetic pole overlap portion overlapping the first coil edge portion in the first direction,
the second magnetic pole edge portion including a second magnetic pole overlap portion overlapping the second coil edge portion in the first direction,
the magnetic pole end portion having a magnetic pole end portion center in a second direction, the second direction connecting the first magnetic pole overlap portion and the second magnetic pole overlap portion,
a distance in the second direction between the first magnetic pole edge portion and a first straight line increasing along a third direction, the third direction being from the magnetic pole end portion center toward the overlap portion center, the first straight line connecting the magnetic pole end portion center and an overlap portion center, the overlap portion center being between the first magnetic pole overlap portion and the second magnetic pole overlap portion,
a distance in the second direction between the first coil edge portion and a second straight line decreasing along the third direction, the second straight line passing through the third coil edge portion and being parallel to the first straight line.
